(19) United States
(12) Patent Application Publication
(10) Pub. No.: US 2016/0280061 A1
(43) Pub. Date: Sep. 29, 2016

(54) A FUEL FILLER ASSEMBLY FOR A VEHICLE

(71) Applicant: ILLINOIS TOOL WORKS INC., Glenview, IL (US)

(72) Inventors: Ravindra S. DESAI, Pune (IN); Shriram M. JOSHI, Pune (IN); Bheemappa G. BIJAPUR, Pune (IN)

(21) Appl. No.: 15/036,830

(22) PCT Filed: Sep. 3, 2014
(86) PCT No.: PCT/US14/53947

§ 371 Date: May 16, 2016

(30) Foreign Application Priority Data
Nov. 19, 2013 (IN) 5330/CHE/2013

(51) Int. Cl. B60K 15/05

(52) U.S. Cl. CPC B60K 15/05; B60K 2015/0561; B60K 2015/053; B60K 2015/0451

(57) ABSTRACT

A fuel filler assembly for a vehicle which includes a housing that can connect to the vehicle and includes a fuel pipe opening. The fuel filler assembly can be connected to the vehicle body with aid of the housing. The fuel pipe opening is provided in the fuel filler assembly to accommodate the fuel pipe through which fuel can be filled to a fuel tank of the vehicle. The fuel filler assembly comprises a hinge arm attached to the housing which is capable of closing and opening the fuel filler assembly. The hinge arm acts as a component to close or to open the fuel filler assembly. When the fuel tank is required to be filled, the hinge arm is opened such that fuel can be filled to the fuel tank.

### FIELD OF INVENTION

The present invention generally relates to fuel filler for vehicles, but not limited thereto. Particularly, the present invention relates to a fuel filler assembly for a motor vehicle where there is limited space to access the fuel filler assembly.

### BACKGROUND OF THE INVENTION

There are lots of scenarios where the fuel fillers present in the existing vehicles are located critically whereby accessing them is very difficult. Due to such limitations in space it is difficult to operate such fuel fillers. Due to such limited space constrains it is difficult to provide an air tight sealing also. The opening and the closing mechanism provided for such fuel fillers are very complex. The locking and unlocking is done by motor lock. This motor lock is more expensive & needs lot of space for assembly & operation. The opening and closing mechanism provided for such fuel fillers are not an integral part of the fuel filler assembly. Accordingly it occupies separate extra space for providing such mechanism.

These Conventional vehicles Fuel filler Assembly need locking and unlocking mechanisms. These mechanisms have various types of plungers. These are mounted on Housing and they locks and unlocks the Hinge arm in assembly. The existing fuel fillers and fuel filler arrangements in this context are not packagable and do not and provide a compact and economical opening and closing arrangement for the existing fuel fillers.

The described foregoing aspects are the drawbacks of the existing technology/knowledge as available in the state of art.

One of the existing knowledge as available in the state of art relates to a fuel filler assembly having a filler and a cap for closing a mouth of the filler and provided internally with a lock cylinder rotated by means of an operating key; for reversibly locking relative rotation of the cylinder with respect to the cap selectively assume, when the cap is fitted closing the filler a first operating position permitting relative rotation of the cylinder with respect to the cap and, hence, withdrawal of the operating key, and, when the cap is detached from the filler a second operating position preventing relative rotation of the cylinder with respect to the cap and, hence, withdrawal of the operating key from the cylinder.

However, none of the existing knowledge as available in the state of art describes or addresses the drawbacks described herein and the existing knowledge as available in the state of art does not suggest or provide a solution to overcome the drawbacks described herein.

Accordingly, none of the existing knowledge as available in the state of art including the existing prior art documents suggest or provide a solution to overcome the drawbacks described herein.

Thus, there is a need for an invention to provide cheaper options & also to overcome the drawbacks described herein. Thus a need exists for Plunger mechanisms to have simple mounting features which should be easy to assemble and disassemble without any tool. There is also need for the plunger to have integrated feature to fix the cable in order to have minimum number of parts which saves the assembly time and makes the part compact.

There is a need for an invention to provide an air tight budding for the fuel tank which is easy to operate.

Particularly, there is a need for an invention to provide a fuel filler assembly which will provide air tight budding for the fuel tank which is easy to operate where there is limited space to operate.

The present invention provides a fuel filler assembly for a vehicle.

### OBJECT OF THE INVENTION

One object of the present invention is to provide a fuel filler assembly for a vehicle.

### SUMMARY OF THE INVENTION

According to one aspect of the present invention, which achieves the above object, relates to a fuel filler assembly for a vehicle which comprises a housing adopted to connect to the vehicle and having a fuel pipe opening. The fuel filler assembly can be connected to the vehicle body with aid of the housing. The fuel pipe opening is provided in the fuel filler assembly through which fuel can be filled to a fuel tank of the vehicle. The fuel filler assembly comprises a hinge arm attached to the housing which is capable of closing and opening the fuel filler assembly. The hinge arm acts as a component to close or to open the fuel filler assembly. When the fuel tank is required to be filled, the hinge arm is opened such that fuel can be filled to the fuel tank. The fuel filler assembly comprises a plunger attached to the housing which is capable of locking the hinge arm with the housing or unlocking the hinge arm from the housing. This new plunger mechanism has snaps on outer body. This does not need any special tool to assemble the plunger on Housing and the Plunger body is extended to integrate the cable end mounting feature. This is a very compact design with less no of parts. A flap is attached to the hinge arm. This acts like a lid to the fuel filler assembly such this flushes with the body of the vehicle. A seal is moulded on the housing around its periphery wherein the seal provides air tight budding with the vehicle panel and the housing.

### BRIEF DESCRIPTION OF DRAWINGS

The features of the present invention will become more clear and apparent from the following description which refers to the accompanying drawings in which,

FIG. 1A illustrates a fuel filler assembly for a vehicle in accordance with an exemplary embodiment of the present invention;

FIG. 1B illustrates the isometric view of the fuel filler assembly;

FIG. 1C illustrates a detailed view of a housing of the fuel filler assembly in accordance with an exemplary embodiment of the present invention;

FIG. 1D illustrates yet another detailed view of the housing of the fuel filler assembly in accordance with an exemplary embodiment of the present invention; and

FIG. 1E illustrates an exploded view of a plunger assembly which gets fitted on the fuel filler assembly in accordance with an exemplary embodiment of the present invention.

The above referred drawings exclusively are figures as briefed and accompanied but not limited thereto.

### DETAILED DESCRIPTION OF THE INVENTION

The present invention will be described herein below with reference to the accompanying drawings.

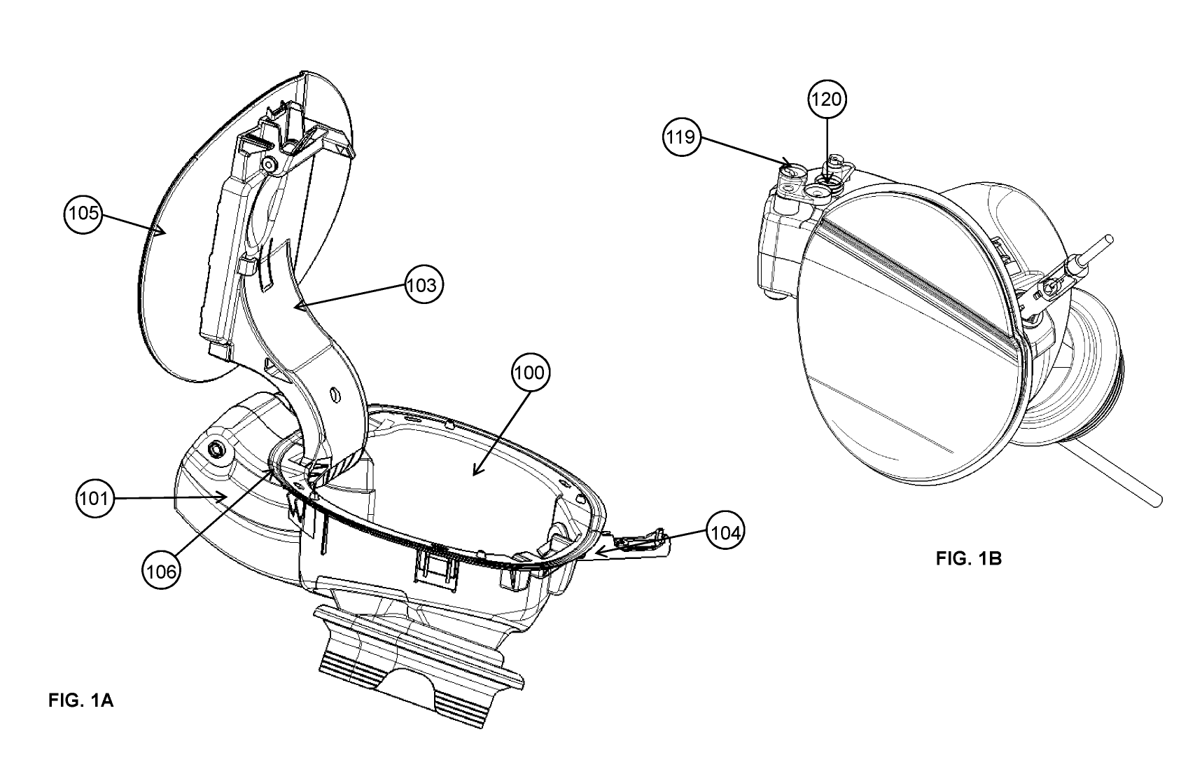

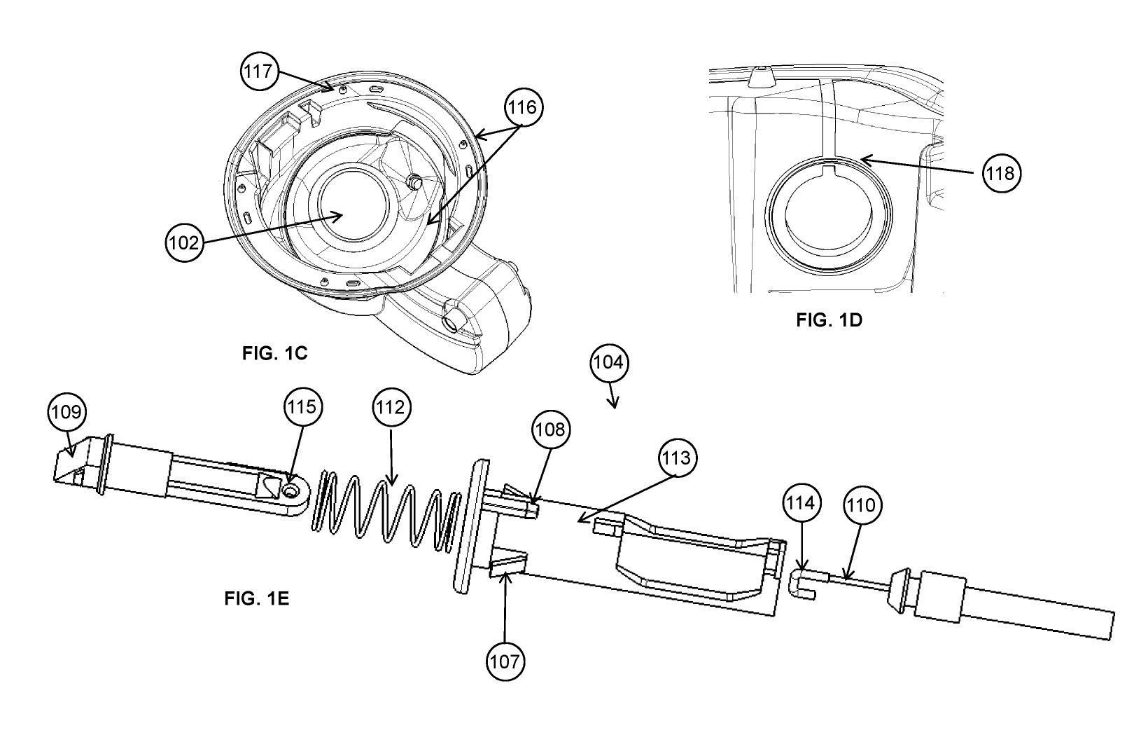

Referring to FIG. 1A to FIG. 1E, a fuel filler assembly for a vehicle is illustrated in accordance with an exemplary embodiment of the present invention.

The fuel filler assembly (100) comprises a housing (101) adopted to connect to the vehicle and having a fuel pipe opening (102). The fuel filler assembly can be connected to the vehicle body with aid of the housing. The fuel pipe opening is provided in the fuel filler assembly to accommodate the fuel pipe through which fuel can be filled to a fuel tank of the vehicle. The fuel filler assembly comprise a hinge arm (103) attached to the housing (101) which is capable of closing and opening the fuel filler assembly (100). The hinge arm acts as a component to close or to open the fuel filler assembly. When the fuel tank is required to be filled, the hinge arm is opened such that fuel can be filled to the fuel tank. The fuel filler assembly comprises a plunger (104) attached to the housing (101) which is capable of locking the hinge arm (103) with the housing (101) or unlocking the hinge arm (103) from the housing (101). A flap (105) is attached to the hinge arm (103). This acts like a lid to the fuel filler assembly such this flushes with the body of the vehicle. A seal (106) is moulded on the housing (101) around its periphery wherein the upper portion of the seal (106) provides air tight butting with the vehicle panel and the housing (101) and the lower portion of the seal (106) provides air tight butting with the vehicle fuel pipe and the housing (101).

The plunger (104) comprise one or more snap (107) to aid the plunger (104) to fit it on to the housing (101). The plunger also has and one or more rectangular locator (108) to guide the plunger (104) in the housing (101) and to prevent the plunger (104) from rotating inside the housing (101).

The plunger (104) comprises a locking head (109) or a pin (109) operatively connected to a cable (110) with aid of an operating means (111) such that the locking head (109) can be unlocked from the hinge arm (103) when required. The cable is operated to unlock the plunger from the hinge arm.

The operating means (111) comprise of a spring (112) loaded to have the locking head (109) intact with the hinge arm (103).

The plunger (104) has a telescopic body (113) operatively accommodating the locking head (109), the spring (112) and the cable (110). This means the locking head with one end of the cable and the spring is accommodated inside the telescopic body of the plunger.

The cable (110), through the operating means (111) is connected to the locking head (109) with a hook (114) and a hole (115) arrangement. The cable (110) can be connected or disconnected from the hole (115) even when fuel filler assembly (100) is intact with the vehicle.

The hosing (101) comprise over moulded rubber seals (116) at upper and lower area of the housing (101). The housing comprise over moulded bump pad (117) on the housing (101) to dampen the flap (105) closing sound and also to maintain the flushness with the vehicle panel and the housing (101) has an over moulded sealing ring (118) for the plunger (104) such that the housing (101) is airtight with the plunger assembly.

The over moulded upper rubber seal (116) provide leak proof sealing between Housing and vehicle body panel, similarly the lower seal provides a leak proof sealing between housing and fuel neck. The over moulded bump pads (117) are added to maintain the flushness between the vehicle body panel and fuel filler assembly flap (105) & also the bump pads reduce the noise while closing the lid. The over moulded sealing ring provides the housing to be airtight with the Plunger assembly (104).

The hinge arm (103) is attached to the housing (101) with aid of a pivot pin (119) and a torsion spring (120) such that the hinge arm (103) is intact with the housing (101) and can move or rotate along the pivot pin and the torsion spring (120) ensures to retain the hinge arm and flap to stay firmly in both open and close condition without any rattling or rattling sound.

The cable (110) can be operated by a user in the vehicle to unlock the locking head (109) and thereby unlocking the flap (105) from the fuel filler assembly whenever required by the user. The lid can be locked just by closing & pushing the lid.

1. A fuel filler assembly (100) for a vehicle the fuel filler assembly (100) comprising:
a housing (101) adopted to connect to the vehicle and having a fuel pipe opening (102);
a hinge arm (103) attached to the housing (101) which is capable of closing and opening the fuel filler assembly (100);
a plunger (104) attached to the housing (101) which is capable of locking the hinge arm (103) with the housing (101) or unlocking the hinge arm (103) from the housing (101);
a flap (105) attached to the hinge arm (103); and
a seal (106) moulded on the housing 101 around its periphery wherein the upper portion of the seal (106) provides air tight butting with the vehicle panel and the housing (101) and the lower portion of the seal (106) provides air tight butting with the vehicle fuel pipe and the housing (101).

2. The fuel filler assembly (100) as claimed in claim 1, wherein the plunger (104) comprise one or more snap (107) to aid the plunger (104) to fit it on to the housing (101) and one or more rectangular locator (108) to guide the plunger (104) in the housing (101) and to prevent the plunger (104) from rotating inside the housing (101).

3. The fuel filler assembly (100) as claimed in claim 2 wherein the plunger (104) comprises a locking head (109) or a pin (109) operatively connected to a cable (110) with aid of an operating means (111) such that the locking head (109) can be unlocked from the hinge arm (103) when required.

4. The fuel filler assembly (100), as claimed in claim 3, wherein the operating means (111) comprise of a spring (112) loaded to have the locking head (109) intact with the hinge arm (103).

5. The fuel filler assembly (100) as claimed in claim 2, wherein the plunger (104) has a telescopic body (113) operatively accommodating the locking head (109), the spring (112) with the cable (110).

6. The fuel filler assembly (100) as claimed in claim 2, wherein the cable (110) through the operating means (111) is connected to the locking head (109) with a hook (114) and a hole (115) arrangement.

7. The fuel filler assembly (100) as claimed in claim 6, wherein the cable (110) can be connected or disconnected from the hole (115) even when fuel filler assembly (100) is intact with the vehicle.

8. The fuel filler assembly (100) as claimed in claim 1, wherein the housing comprise over moulded bump pad (117) on the housing (101) to dampen the flap (105) closing sound and also to maintain the flushness with the vehicle panel and the housing (101) has a over moulded sealing ring (118) for the plunger (104) such that the housing (101) is airtight with the plunger assembly.

9. The fuel filler assembly (100) as claimed in claim 1, wherein the hinge arm (103) is attached to the housing (101) with aid of a pivot pin (119) and a torsion spring (120) such that the hinge arm (103) is intact with the housing (101) and can move or rotate along the pivot pin and the torsion spring (120) ensures to retain the hinge arm and flap to stay firmly in both open and closed condition without any rattling.

10. The fuel filler assembly (100) as claimed in claim 1, wherein the cable (110) can be operated by a user in the vehicle to unlock the locking head (109) and thereby unlocking the flap (105) from the fuel filler assembly.
